(19) United States
(12) Patent Application Publication
(10) Pub. No.: US 2021/0350946 A1
(43) Pub. Date: Nov. 11, 2021

(54) SYSTEM AND METHOD OF RECOVERING A PARENT RADIONUCLIDE FROM A RADIONUCLIDE GENERATOR

(71) Applicants: ITM Isotopen Technologien München AG, Garching/Munich (DE); TRIUMF, A JOINT VENTURE OF THE GOVENORS OF THE UNIVERSITY OF ALBERTA, THE UNIVERSITY OF BRITISH COLU, Vancouver (CA)

(72) Inventors: Stefan K. ZEISLER, Vancouver (CA); Ellard PORTMAN, Vancouver (CA)

(73) Assignees: ITM Isotopen Technologien München AG, Garching/Munich (DE); TRIUMF, A JOINT VENTURE OF THE GOVENORS OF THE UNIVERSITY OF ALBERTA, THE UNIVERSITY OF BRITISH COLU, Vancouver (CA)

(21) Appl. No.: 17/061,735

(22) Filed: Oct. 2, 2020

Related U.S. Application Data
(60) Provisional application No. 62/926,263, filed on Oct. 25, 2019.

(51) Int. Cl. G21G 1/00; G21G 4/06; B01D 15/38

(52) U.S. Cl. CPC G21G 1/0005; B01D 15/3804; G21G 4/06

(57) ABSTRACT

A method for recovering a parent radionuclide from a radionuclide generator is disclosed where the parent radionuclide is adsorbed to a stationary phase. The method contains a series of elutions. At least one elution is with an alcohol. At least one elution with water. At least one elution is with a mineral acid other than hydrochloric acid that is paused to soak the stationary phase with the mineral acid.

### FIELD OF INVENTION

The present invention relates to methods for recovering a parent radionuclide from a radionuclide generator. In particular, the methods of the invention relate to recovering germanium-68 from a germanium-68/gallium-68 generator.

### BACKGROUND

Radionuclides, or radioisotopes, are widely used in nuclear medicine for the diagnosis and treatment of disease. However, one of the practical issues faced in nuclear medicine is the desirability to use metastable short-lived radionuclides and at the same time have the radionuclides ready on demand in a hospital or clinical setting.

To address this problem, radionuclide generator systems have been developed. The generator systems comprise a parent-daughter radionuclide pair contained in an apparatus, the parent radionuclide having a longer half-life than the daughter radionuclide. The daughter radionuclide activity is replenished continuously by decay of the parent radionuclide meaning that the daughter radionuclide can be extracted repeatedly. Storage, transportation and on-demand extraction of the daughter radionuclide is therefore possible.

Two of the most widely used radionuclide generators are Mo-99/Tc-99m and Ge-68/Ga-68 generators. Tc-99m, which is used in medical imaging, has a half-life of 6 hours, whereas Mo-99 has a half-life of 66 hours. Ga-68, which is used in PET scanning has a half-life of 68 minutes, whereas Ge-68 has half-life of 270.82 days. Other parent/daughter radionuclide pairs for radionuclide generators include W-188/Re-188, Zn-62/Cu-62, Rb-81/Kr-81m and Sr-82/Rb-82.

Historically, radionuclide generators were based on liquid-liquid extraction techniques and were given the nickname “cows”, based on the fact that the daughter radionuclide could be “milked” from the parent nuclide. Modern methods are typically based on solid phase-based column chromatography. A number of different systems using combinations of inorganic or organic solid phases and mobile phases have been proposed and are commercially available.

In a typical generator system, the parent radionuclide is specifically adsorbed to a stationary phase or support material e.g. within a chromatography column. The daughter radionuclide should have a lower affinity for the support material so that it can be readily removed (e.g. eluted) from the generator.

The stationary phase or support material of the generator is typically an ion exchange resin such as alumina, TiO₂, SnO₂ or SiO₂. The mobile phase is a solvent that is able to elute the daughter radionuclide after it has been produced by decay of the immobilized parent radionuclide. With columns comprising silica-based resins as the stationary phase, diluted hydrochloric acid is often used as the mobile phase. For alumina columns, saline is usually used as the mobile phase.

A parent radionuclide that is loaded into a generator column can be produced by a number of methods. For example, the most common method of producing Mo-99 is through fission of uranium-235 in a nuclear reactor. Ge-68 may be produced by proton accelerators, e.g. by proton capture after proton irradiation of Nb-encapsulated gallium metal, by proton capture and double neutron knockout from gallium-69 (Ga-69(p,2n)Ge-68) or by accelerator-produced helium ion (alpha) irradiation of zinc-66 after double neutron knockout (Zn-66(a,2n)Ge-68).

While in principle the physical half-life of a parent radionuclide should allow utility of the generator for a time period that is much longer than the half-life of the parent radionuclide, the shelf life of a generator does not necessarily parallel the physical half-life of the parent radionuclide. Decreasing qualities of the generator itself, such as reduced daughter radionuclide yield, degradation of the stationary phase and in particular parent radionuclide breakthrough mean that the shelf life of a generator is significantly shorter than the lifetime potential of the parent radionuclide.

For example, Ge-68/Ga-68 generators have a typical shelf life of one year, which is similar to the physical half-life of Ge-68 (270.82 days). Accordingly, upon expiry, around 40% of the initial Ge-68 activity remains in the generator.

To date, an effective commercial process for the recovery of parent radionuclides from radionuclide generators has not been developed.

### SUMMARY OF THE INVENTION

According to an aspect of the present invention there is provided a method for recovering a parent radionuclide from a radionuclide generator, the radionuclide generator comprising the parent radionuclide adsorbed to a stationary phase, the method comprising a series of elutions comprising:
at least one elution with an alcohol;
at least one elution with a mineral acid; and
at least one elution with water;
   where the at least one elution with a mineral acid is paused to soak the stationary phase with the mineral acid, and
   the mineral acid does not comprise hydrochloric acid.

According to another aspect of the present invention, there is provided method for recovering a parent radionuclide from a radionuclide generator comprising the parent radionuclide adsorbed to a stationary phase, the method comprising:
(i) eluting the stationary phase with an alcohol one or more times to obtain an alcohol eluate;
(ii) eluting the stationary phase with a mineral acid one or more times to obtain a mineral acid eluate;
(iii) eluting the stationary phase with water one or more times to obtain an aqueous eluate;
(iv) isolating the parent radionuclide, from the alcohol eluate obtained in step (i), the mineral acid eluate obtained in step (ii) and the aqueous eluate obtained in step (iii);
   where step (ii) comprises pausing the one or more mineral acid elution to soak the stationary phase with the mineral acid, and
   the mineral acid does not comprise hydrochloric acid.

According to another aspect of the present invention, there is provided a parent radionuclide recovered according to the methods described herein.

According to another aspect of the present invention, there is provided method for recycling a parent radionuclide from a first radionuclide generator for reuse in a second radionuclide generator, the method comprising,
(i) providing a first radionuclide generator, the radionuclide generator comprising the parent radionuclide adsorbed to a stationary phase
(ii) eluting the stationary phase of the first radionuclide generator with an alcohol one or more times to obtain an alcohol eluate;
(iii) eluting the stationary phase of the first radionuclide generator with a mineral acid one or more times to obtain a mineral acid eluate;
(iv) eluting the stationary phase of the first radionuclide generator with water one or more times to obtain an aqueous eluate;
(v) isolating the parent radionuclide from the alcohol eluate obtained in step (ii), the mineral acid eluate obtained in step (iii) and the aqueous eluate obtained in step (iv);
(vi) loading the isolated parent radionuclide into the second radionuclide generator, such that the parent radionuclide is adsorbed to a stationary phase of the second radionuclide generator;
   where step (ii) comprises pausing the one or more mineral acid elution to soak the stationary phase with the mineral acid, and
   the mineral acid does not comprise hydrochloric acid.

Applicant surprisingly found that the described series of elutions are effective in disengaging or decoupling the parent radionuclide from the stationary phase of a radionuclide generator. The methods of the invention make it possible to recover the parent radionuclide with high yield (≥88%), high chemical and radiochemical purity, and in a form suitable for the production of new radionuclide generators.

In some embodiments, the mineral acid may comprise hydroiodic acid (HI) and/or hydrobromic acid (HBr). In particular for the recovery of Ge-68, avoiding the use of HCl is preferable to avoid the formation of volatile gaseous germanium compounds such as GeCl₄. Methods of the invention comprising HI and HBr mineral acid allow the parent radionuclide to be recovered safely and efficiently without the formation of GeCl₄ which would create a significant contamination hazard and lower the overall process yield. On the other hand, methods using ethanol and dilute hydrochloric acid as eluents were found to obtain significantly lower yields and clogging of the column was found to be a major obstacle.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a schematic of the methods of recovering a parent radionuclide according to an embodiment of the present invention;

FIG. 2 is a graph showing yield of Ge-68 as a function of number of elutions performed for methods of recovery according to an embodiment of the present invention. The elution regimes for Rounds 1-6 are described in Tables 1-6 below; and

FIGS. 3A-F show the yield of Ge-68 recovered after each elution in Rounds 1-6, categorized by elution type in accordance with an embodiment of the present invention.

### DETAILED DESCRIPTION

The term “radionuclide” refers to an atom with excess nuclear energy making it unstable and that undergoes radioactive decay. Radionuclides are also known as radioactive nuclides, radioisotopes or radioactive isotopes. Radioactive decay may produce a new stable nuclide, or a new unstable radionuclide, which may undergo further decay. The term “parent radionuclide” in the context of the present invention refers to a radionuclide that decays into a new radionuclide, or “daughter radionuclide”. Examples of parent radionuclides and their daughter radionuclides include Mo-99/Tc-99m, Ge-68/Ga-68 and W-188/Re-188.

The term “radionuclide complex” refers to any compound or salt comprising the radionuclide. In the methods of the present invention, the parent radionuclide may be present in the eluates as a radionuclide complex. For example, the parent radionuclide may elute bound to part of the stationary phase (e.g. ⁶⁸Ge-laurylgallate, ⁶⁸Ge-silica), or may react with the mineral acid and elute as a new complex (e.g. ⁶⁸GeCl₄, ⁶⁸GeI₄). The radionuclide complexes obtained from elution with HI and Br, i.e. GeI₄ (melting point 144° C.) and GeBr₄ (melting point 26° C. and boiling point 186° C.), are stable at room temperature and non-volatile. The parent radionuclide may be isolated as a radionuclide complex which may be used directly for loading into a new radionuclide generator.

The term “radionuclide generator” refers to a system containing a parent radionuclide which decays into a daughter radionuclide, where the half-life of the parent is longer than the half-life of the daughter. The decay of the parent to the daughter is continuous and the daughter radionuclide can be extracted repeatedly. Radionuclide generators typically comprise an ion exchange column in which the parent radionuclide is bound (adsorbed) to a stationary phase in the column. The daughter radionuclide can be obtained by eluting the stationary phase with a mobile phase to release the daughter radionuclide from the stationary phase. The radionuclide generator may be partially depleted. By partially depleted, it is meant that the parent radionuclide has undergone decay, but the generator is not completely exhausted of activity.

Common stationary phases for radionuclide generators include oxidic substrates such as silica (SiO₂), alumina (Al₂O₃), zirconia (ZrO₂), titanium oxide (TiO₂), tin oxide (SnO₂), tantalum oxide (Ta₂O₅), vanadium oxide (V₂O₅) and niobium oxide (Nb₂O₃). Common mobile phases for eluting daughter radionuclides from the stationary phase include hydrogen chloride (HCl) and saline.

The terms “elution”, “eluting”, “eluent” and “eluate” are known in the art. Elution and eluting refers to the process of washing or rinsing the stationary phase with a mobile phase to extract or separate a substance or material from the stationary phase. “An elution” refers to a single wash or rinse of the stationary phase with the mobile phase. The “eluent” is the mobile phase that the stationary phase is washed with and the resulting solution containing the extracted substance and the mobile phase which is obtained from the elution or eluting is the “eluate”.

Pausing an elution to increase the contact time between the eluent and the stationary phase is also known in the art. When an elution is paused, discharge of the eluent is prevented such that the eluent remains in contact with the stationary phase. In other words, the stationary phase is soaked with the eluent. The “soak time” or “contact time” in the context of the invention refers to the amount of time that the eluent (e.g. mineral acid) is in contact with the stationary phase when an elution is paused. The “total soak time” refers to the sum of the soak times of each of the one or more elutions.

The term “concentrated” in the context of “concentrated acid” or “concentrated mineral acid” refers to the maximum concentration of an acid in an aqueous solution, or within 10% of the maximum % concentration. For example, the maximum concentration of HCl owing to its solubility in water is around 38%. The maximum concentration of HI is around 57%. The maximum concentration of HBr is around 48%. The term “diluted” in the context of “dilute acid” refers to an acid concentration below the maximum concentration, or a concentration lower than 10% below the maximum percentage concentration.

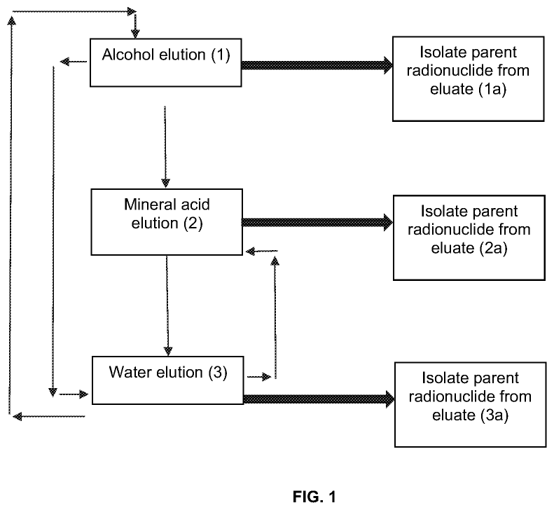

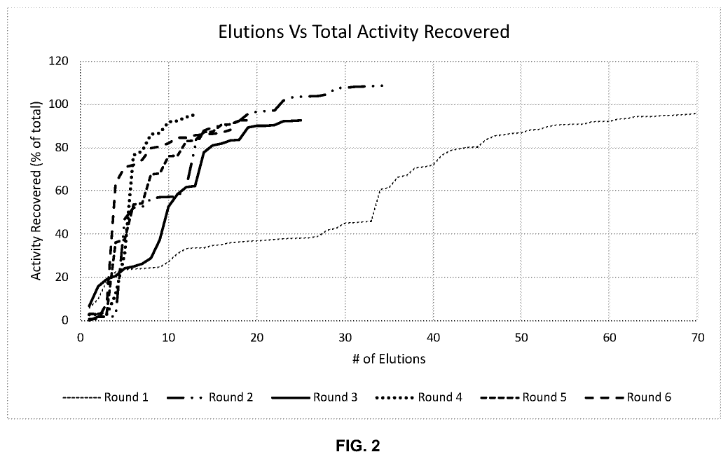

The term “elution regime” in the context of the recovery methods of the present invention refers to the series of elutions carried out on the stationary phase of a radionuclide generator. A schematic of the fundamental elution regime according to the invention is shown in FIG. 1. The line arrows indicate the order in which the elutions may be carried out and the block arrows indicate recovery of the parent radionuclide. In general, the elution regime starts with an alcohol elution (1) and is followed by one or more mineral acid elution (2). Each mineral acid elution is paused in order to soak the stationary phase with the mineral acid. Each mineral acid elution is followed by a water elution (3). The parent radionuclide is then isolated from the alcohol eluate (1a) obtained from the alcohol elution(s) (1), the mineral acid eluate (2a) obtained from the mineral acid elution(s) (2), and the aqueous eluate (3a) obtained from the water elution(s) (3).

The term “laurylgallate”, otherwise known as dodecyl gallate or Dodecyl 3,4,5-trihydroxybenzoate, refers to the chemical compound having formula C₁₉H₃₀O₅.

The term “chemical purity” can be defined as the proportion (e.g. percentage) of the desired chemical or compound in a sample.

The term “radiochemical purity” refers to the amount of total radioactivity in a sample which is present as the desired radionuclide.

In the context of the present invention, “yield” of the parent radionuclide refers to the amount of parent radionuclide recovered compared to the total amount of parent radionuclide present in the generator. The yield of the radionuclide can be measured in terms of radioactivity e.g. in becquerels (Bq).

The term “isolating” in the context of isolating the parent radionuclide as described in the present invention refers to separating or extracting the parent radionuclide from a matrix (e.g. an alcohol, mineral acid or aqueous eluate). Isolation (extraction) techniques include, but are not limited to, liquid-liquid extraction and solid-phase extraction. The Applicant has developed an efficient liquid-liquid extraction for mineral acid and aqueous eluates containing a parent radionuclide using chlorinated organic solvents such as chloroform. The parent radionuclide extracts can then be dissolved in dilute HCl (e.g. 0.001N-1N) ready for loading into a new generator. However, the isolation (extraction) method may also be performed by replacing chloroform with any other chlorinated hydrocarbon that is non-miscible with aqueous solvents, for example, carbon tetrachloride (CCl₄) or dichloromethane (CH₂Cl₂). The extraction can also be performed with other non-water miscible organic phases in which the germanium halides are soluble, for example, benzene, toluene, carbon disulfide.

The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like.

As used herein, the terms “comprising,” “having,” “including” and “containing,” and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method or use functions. The term “consisting of” when used herein in connection with a composition, use or method, excludes the presence of additional elements and/or method steps. A use or method described herein as comprising certain elements and/or steps may also, in certain embodiments consist essentially of those elements and/or steps, and in other embodiments consist of those elements and/or steps, whether or not these embodiments are specifically referred to.

As used herein, the terms “about” or “around”, when used to describe a recited value, means within 10% of the recited value, unless otherwise stated.

The present invention will be further illustrated in the following examples.

### EXAMPLE 1

### Recovery of Ge-68 Using Alcohol and HCl

Partially depleted Ge-68/Ga-68 generator columns were obtained for preliminary testing. A series of elutions with ethanol and dilute hydrochloric acid (up to 6N) were performed. It was found that it was not possible to use hydrochloric acid of concentrations above 6N due to the formation of highly volatile ⁶⁸GeCl₄ (boiling point 84° C.).

Recovery yields of Ge-68 in the order of 50-70% were achieved. It was found that the generator column became clogged easily, preventing efficient elution.

### EXAMPLE 2

### Recovery of Ge-68 Using Alcohol and HI/HBr

### Column Preparation

Ge-68/Ga-68 generator columns were obtained from ITG (ITM Isotopen Technologien Munchen AG). The generator column specifications were as follows—column material: silica gel modified with laurylgallate (CAS: 166-52-5); primary package: PEEK column; secondary package: lead containers; lead shielding: 36-50 mm thickness; shelf life: 12 months or 250 elutions; eluent for obtaining daughter Ga68: sterile 0.05 M aqueous hydrochloric acid solution; nominal Ge-68 activity at manufacture 0.3 GBq-2 GBq. The generator columns selected for testing had a range of ages (see Table 3).

The generator columns were dried and any residual hydrochloric acid was removed by flowing pressurized air through the column.

### Elution of Ge-68

The elution regimes and acid soak times as carried out on the generators tested are shown in Tables 1-6 below.

The elutions were carried out as follows. The column was eluted with methanol (10-20 mL) at room temperature and the methanol eluate collected. Elutions with concentrated hydroiodic acid (57%) and/or hydrobromic acid (48%) (4-15 mL) at room temperature were performed and each acid elution was followed by elution with milli Q (MQ) water (10-20 mL) at ˜100° C. The mineral acid and aqueous eluates were collected. During each elution with hydroiodic acid and/or hydrobromic acid, the elution was paused halfway so that the column remained in contact with the acid (soaking) for the indicated time period. The elution regime of methanol, and hydroiodic acid/hydrobromic acid followed by a water flush was repeated as necessary.

### Elution Regimes

TABLE 1
Round 1 elution regime

| Elution | Volume (ml) | Activity Recovered (MBq) | Soak Time (Hrs) |
|---|---|---|---|
| Me[OH] 1 | 10 | 11.85 | |
| Me[OH] 2 | 10 | 8.24 | |
| Me[OH] 3 | 15 | 17.26 | |
| Me[OH] 4 | 15 | 9.23 | |
| Me[OH] 5 | 15 | 1.99 | |
| Me[OH] 6 | 15 | 0.68 | |
| Me[OH] 7 | 15 | 0.354 | |
| Me[OH] 8 | 15 | 0.528 | |
| Me[OH] 9 | 15 | 0.704 | |
| MQ H₂O 1 | 15 | 5.25 | |
| HBr 1 | 15 | 8.05 | 1.7 |
| MQ H₂O 2 | 15 | 4.54 | |
| HBr 2 | 15 | 0.695 | 1.8 |
| HBr 3 | 15 | 0.12 | 1.3 |
| MQ H₂O 3 | 15 | 2.23 | |
| HBr4 | 10 | 0.783 | 0.5 |
| MQ H₂O 4 | 10 | 2.06 | |
| HBr 5 | 10 | 0.379 | 0.7 |
| MQ H₂O 5 | 10 | 0.885 | |
| HBr 6 | 10 | 0.27 | 0.8 |
| MQ H₂O 6 | 10 | 0.813 | |
| MQ H₂O 7 | 10 | 0.371 | |
| Me[OH] 10 | 15 | 0.858 | |
| Me[OH] 11 | 15 | 0.286 | |
| Me[OH] 12 | 15 | 0.168 | |
| MQ H₂O 8 | 15 | 0.532 | |
| HBr 7 | 15 | 1.25 | 0.7 |
| MQ H₂O 9 | 15 | 6.01 | |
| HBr 8 | 15 | 1.692 | 0.8 |
| MQ H₂O 10 | 15 | 5.2 | |
| Me[OH] 13 | 20 | 0.109 | |
| MQ H₂O 11 | 15 | 0.649 | |
| HI 1 | 15 | 0.963 | 0.9 |
| MQ H₂O 12 | 20 | 30.4 | |
| HI 2 | 20 | 1.502 | 0.6 |
| MQ H₂O 13 | 15 | 9.98 | |
| Me[OH] 14 | 15 | 1.803 | |
| MQ H₂O 14 | 20 | 7.48 | |
| HI 3 | 15 | 0.654 | 1.0 |
| MQ H₂O 15 | 15 | 1.951 | |
| MQ H₂O 16 | 15 | 9.43 | |
| MQ H₂O 17 | 15 | 4.41 | |
| Me[OH] 15 | 15 | 1.436 | |
| MQ H₂O 18 | 15 | 1.433 | |
| HI 4 | 15 | 0.374 | 0.9 |
| MQ H₂O 19 | 15 | 6.9 | |
| MQ H₂O 20 | 15 | 3.75 | |
| Me[OH] 16 | 10 | 0.97 | |
| MQ H₂O 21 | 15 | 1.426 | |
| HI 5 | 15 | 0.328 | 0.7 |
| MQ H₂O 22 | 15 | 3.09 | |
| HI 6 | 15 | 0.439 | 0.6 |
| MQ H₂O 23 | 15 | 2.67 | |
| MQ H₂O 24 | 15 | 1.56 | |
| MQ H₂O 25 | 10 | 0.329 | |
| Me[OH] 17 | 10 | 0.37 | |
| HI 7 | 10 | 0.027 | 0.8 |
| MQ H₂O 26 | 15 | 2.4 | |
| Me[OH] 18 | 10 | 0.244 | |
| HI 8 | 15 | 0.028 | 0.7 |
| MQ H₂O 27 | 15 | 2.31 | |
| HI 9 | 10 | 0.422 | 0.5 |
| MQ H₂O 28 | 15 | 1.708 | |
| MQ H₂O 29 | 10 | 0.17 | |
| Me[OH] 19 | 15 | 0.073 | |
| MQ H₂O 30 | 10 | 0.912 | |
| HBr 9 | 10 | 0.057 | 0.7 |
| MQ H₂O 31 | 15 | 0.743 | |
| HI 10 | 10 | 0.07 | 0.7 |
| MQ H₂O 32 | 15 | 1.571 | |

TABLE 2
Round 2 elution regime

| Elution | Volume (ml) | Activity Recovered (MBq) | Soak Time (hrs) |
|---|---|---|---|
| Me[OH] 1 | 20 | 0.36 | |
| MQ H₂O 1 | 15 | 8.03 | |
| MQ H₂O 2 | 15 | 0.029 | |
| MQ H₂O 3 | 15 | 0.03 | |
| Me[OH] 2 | 20 | 202 | |
| Syringe Rinse | 15 | 22.6 | |
| (H₂O) 1 | | | |
| Syringe Rinse | 15 | 1.491 | |
| (H₂O) 2 | | | |
| Me[OH] 3 | 15 | 17.71 | |
| Me[OH] 4 | 15 | 2.97 | |
| Me[OH] 5 | 15 | 0.501 | |
| MQ H₂O 4 | 15 | 0.565 | |
| HI 1 | 15 | 20.4 | 19.3 |
| MQ H₂O 5 | 15 | 83.4 | |
| MQ H₂O 6 | 15 | 32.5 | |
| Me[OH] 6 | 15 | 7.68 | |
| MQ H₂O 7 | 15 | 2.72 | |
| HI 2 | 15 | 2.28 | 1.3 |
| MQ H₂O 8 | 15 | 7.99 | |
| MQ H₂O 9 | 15 | 14.1 | |
| Me[OH] 7 | 15 | 4.41 | |
| MQ H₂O 10 | 15 | 1.887 | |
| HI 3 | 15 | 1.115 | 19.0 |
| MQ H₂O 11 | 15 | 20.4 | |
| MQ H₂O 12 | 15 | 6.31 | |
| Me[OH] 8 | 10 | 1.506 | |
| MQ H₂O 13 | 15 | 0.727 | |
| HI 4 | 10 | 0.521 | 19.5 |
| MQ H₂O 14 | 10 | 3.64 | |
| MQ H₂O 15 | 10 | 13.36 | |
| HI 5 | 10 | 0.225 | 1.8 |
| MQ H₂O 16 | 10 | 1.99 | |
| MQ H₂O 17 | 10 | 0.502 | |
| MQ H₂O 18 | 10 | 1.057 | |
| MQ H₂O 19 | 10 | 0.746 | |
| MQ H₂O 20 | 10 | 0.629 | |

TABLE 3
Round 3 elution regime

| Eluent | Volume (ml) | Activity (MBq) | Soak Time (Hrs) |
|---|---|---|---|
| Water | 10 | 8.8 | |
| Me[OH] 1 | 10 | 11.78 | |
| Me[OH]2 | 10 | 4.44 | |
| Me[OH] 3 | 10 | 1.961 | |
| Me[OH] 4 | 10 | 4.6 | |
| Me[OH] 5 | 10 | 1.045 | |
| MQ H₂O 1 | 40 | 1.754 | |
| HI 1 | 10 | 3.42 | 1.7 |
| MQ H₂O 2 | 10 | 10.85 | |
| MQ H₂O 3 | 10 | 20.2 | |
| MQ H₂O 4 | 10 | 7.57 | |
| MQ H₂O 5 | 10 | 4.38 | |
| HI 2 | 10 | 0.538 | 76.9 |
| MQ H₂O 6 | 10 | 20.4 | |
| MQ H₂O 7 | 10 | 4.1 | |
| Me[OH] 6 | 10 | 1.208 | |
| MQ H₂O 8 | 10 | 1.725 | |
| HI 3 | 10 | 0.531 | 71.9 |
| MQ H₂O 9 | 20 | 7.485 | |
| MQ H₂O 10 | 20 | 0.932 | |
| MQ H₂O 11 | 20 | 0.1 | |
| HI 4 | 10 | 0.25 | 18.7 |
| MQ H₂O 12 | 20 | 2.33 | |
| MQ H₂O 13 | 20 | 0.25 | |
| MQ H₂O 14 | 20 | 0.358 | |

TABLE 4
Round 4 elution regime

| Eluent | Volume | Activity Recovered (MBq) | Soak Time (Hrs) |
|---|---|---|---|
| Me[OH] 1 | 20 | 38.1 | |
| Me[OH] 2 | 20 | 2.01 | |
| Me[OH] 3 | 20 | 0.616 | |
| MQ H₂O 1 | 20 | 126.865 | |
| HI 1 | 10 | 259 | 21.7 |
| MQ H₂O 2 | 20 | 621 | |
| HI 2 | 10 | 26.8 | 22.8 |
| MQ H₂O 3 | 20 | 106.2 | |
| HI 3 | 10 | 7.45 | 69.7 |
| MQ H₂O 4 | 20 | 70.2 | |
| HI 4 | 10 | 6.58 | 0.7 |
| MQ H₂O 5 | 20 | 24.6 | |
| MQ H₂O 6 | 10 | 15.12 | |

TABLE 5
Round 5 elution regime

| Eluent | Volume | Activity Recovered (MBq) | Soak Time (Hrs) |
|---|---|---|---|
| Me[OH] 1 | 20 | 41.3 | |
| MQ H₂O 1 | 20 | 0.15 | |
| HI 1 | 10 | 10.28 | 23.0 |
| MQ H₂O 2 | 20 | 432 | |
| HI 2 | 10 | 17.79 | 4.0 |
| MQ H₂O 3 | 20 | 218 | |
| HI 3 | 10 | 8.93 | 18.6 |
| MQ H₂O 4 | 20 | 177 | |
| HI 4 | 10 | 7.04 | 3.2 |
| MQ H₂O 5 | 20 | 107.3 | |
| HI 5 | 10 | 3.78 | 18.6 |
| MQ H₂O 6 | 20 | 89.5 | |
| HI 6 | 10 | 3.17 | 4.2 |
| MQ H₂O 7 | 20 | 52.8 | |
| HI 7 | 10 | 2.09 | 18.8 |
| MQ H₂O 8 | 20 | 42.7 | |
| HI 8 | 10 | 2.16 | 3.0 |
| MQ H₂O 9 | 20 | 24.6 | |
| MQ H₂O 10 | 20 | 0.912 | |

TABLE 6
Round 6 elution regime

| Eluent | Volume | Activity Recovered (MBq) | Soak Time (Hrs) |
|---|---|---|---|
| Me[OH] 1 | 20 | 8.79 | |
| MQ H₂O 1 | 20 | 3.01 | |
| HI 1 | 4 | 93.4 | 47.5 |
| MQ H₂O 2 | 20 | 721 | |
| MQ H₂O 3 | 20 | 95.3 | |
| HI 2 | 4 | 12.56 | 22.4 |
| MQ H₂O 4 | 20 | 32.4 | |
| MQ H₂O 5 | 20 | 68.9 | |
| HI 3 | 4 | 11.7 | 68.0 |
| MQ H₂O 6 | 30 | 18.51 | |
| MQ H₂O 7 | 20 | 33.7 | |
| HI 4 | 4 | 0.728 | 4.6 |
| MQ H₂O 8 | 20 | 14.2 | |
| MQ H₂O 9 | 20 | 4.51 | |
| HI 5 | 4 | 3.55 | 26.6 |
| MQ H₂O 10 | 20 | 5.98 | |
| MQ H₂O 11 | 20 | 18.27 | |

Table 7 shows the activity recovered for each generator compared to the acid soak time. It was found that the mineral acid elution itself was not as effective at carrying activity (eluting the parent radionuclide) as the water elution that followed each mineral acid elution.

TABLE 7

| | | | | | | Average activity | Average activity |
|---|---|---|---|---|---|---|---|
| | | | | | | recovered after | recovered after |
| | HI soak | | HBr soak | Total | Average | each acid soak | each acid soak |
| | time/hours | | time/hours | acid soak | length of | (measured from | (measured from |
| | (no. of HI | | (no. of HBr | time/ | each acid | acid eluate)/ | subsequent water |
| Round | elutions) | | elutions) | hours | soak/hours | MBq | eluate)/MBq |
| 1 | 7.4 | (10) | 9.0 (9) | 16.4 | 0.86 | 0.46 | 2.30 |
| 2 | 60.9 | (5) | — | 60.9 | 12.18 | 1.10 | 5.26 |
| 3 | 169.2 | (4) | — | 169.2 | 42.3 | 0.91 | 7.86 |
| 4 | 114.9 | (4) | — | 114.9 | 28.73 | 5.48 | 15.01 |
| 5 | 93.4 | (8) | — | 93.4 | 11.68 | 0.52 | 10.67 |
| 6 | 169.1 | (5) | — | 169.1 | 33.82 | 24.39 | 158.42 |

### Isolation and Purification of Ge-68

The methanol eluates were evaporated to near dryness and the remaining Ge-68 extracts were dissolved in an excess of dilute hydrochloric acid (0.05 M). The hydroiodic/hydrobromic eluates and the aqueous eluates were each mixed with chloroform and the chloroform phases containing ⁶⁸GeI₄ and/or ⁶⁸GeBr₄ were retained. The chloroform phases were evaporated to dryness and the extracts dissolved in a small quantity of methanol and then diluted with an excess of hydrochloric acid (0.05 M). The resulting hydrochloric acid solution containing Ge-68 as ⁶⁸GeI₄ and/or ⁶⁸GeBr₄ was loaded into a new Ge-68/Ga-68 generator column. The new generator columns containing the recycled Ge-68 were confirmed to be effective in producing the Ga-68 daughter radionuclide using the standard method of eluting with dilute hydrochloric acid (0.05 M).

Although commercial Ge-68/Ga-68 generators are typically prepared by loading the column with ⁶⁸GeCl₄ in dilute hydrochloric acid, it was found that higher homologues such as ⁶⁸GeI₄ and ⁶⁸GeBr₄ behave identically to ⁶⁸GeCl₄ as regards loading new generator columns.

### EXAMPLE 2

### Yield of Ge-68

The yield of Ge-68 obtained from each elution regime was assessed by measuring the radioactivity of each eluate emerging from the generator column using a CRC®-55tR Dose Calibrator (Captintec, Inc.).

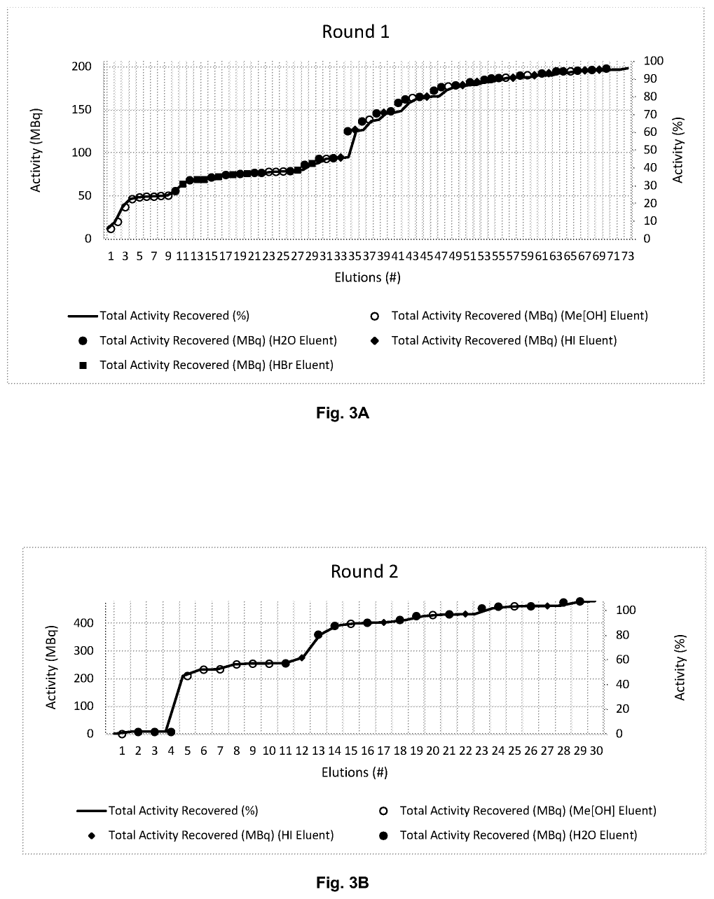

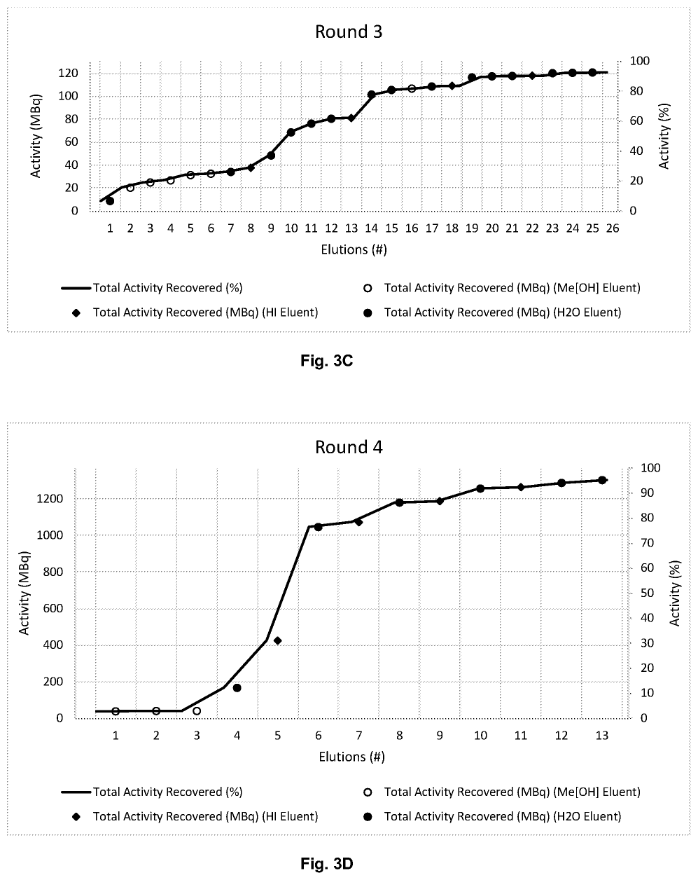

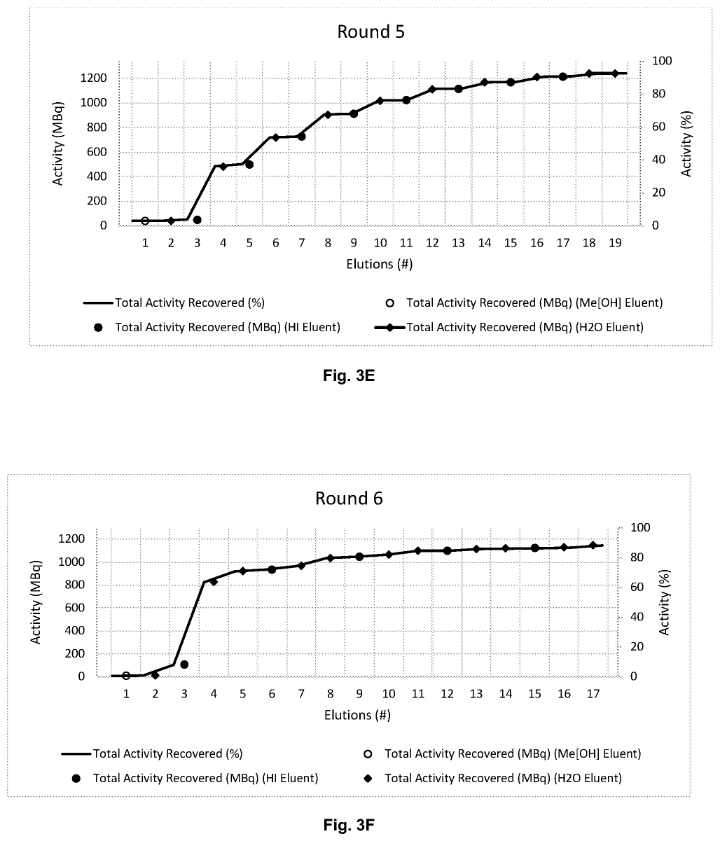

The total activity recovered (% yield) as a function of the number of elutions is shown in FIGS. 2 and 3A-E. The results show that a high yield percentage (>88%) could be obtained regardless of the age of the generator (see Table 8).

Without wishing to be bound by theory, it is thought that elution with alcohol, e.g. methanol, removes Ge-68 in chelate form with laurylgallate, as well as laurylgallate itself, from the generator. It was found that the first methanol elution from each elution regime removed a significant yield of Ge-68, whereas subsequent methanol elutions were substantially diminished in activity relative to the first alcohol elution.

In contrast, it is thought that the mineral acid elution (e.g. HI and/or HBr) is complementary to the alcohol elution and primarily targets Ge-68 bonded to silica. Removal of Ge-68 from the silica matrix is thought to be crucial for high yield recovery. The method exemplified in the present application for a generator with a silica stationary phase may be applied to all oxidic substrates commonly used for radionuclide generator columns, for example, alumina (Al₂O₃), zirconia (ZrO₂), titanium oxide (TiO₂), tin oxide (SnO₂), tantalum oxide (Ta₂O₅), vanadium oxide (V₂O₅) and niobium oxide (Nb₂O₃).

TABLE 8

| | Age of generator | Original | Decay corrected | Total activity recovered |
|---|---|---|---|---|
| Elution Round | (days) | activity (MBq) | current activity (MBq) | (%) |
| 1 | 818 | 1914 | 206.6 | 96.1% |
| 2 | 664 | 1831 | 446.9 | −100% |
| 3 | 728 | 952 | 130.6 | 92.7% |
| 4 | 52 | 1580 | 1397 | 93.4% |
| 5 | 62 | 1570 | 1339.6 | 92.7% |
| 6 | 87 | 1610 | 1146.5 | 88.2% |

All citations are hereby incorporated by reference.

The present invention has been described with regard to one or more embodiments. However, it will be apparent to persons skilled in the art that a number of variations and modifications can be made without departing from the scope of the invention as defined in the claims.

The scope of the claims should not be limited by the preferred embodiments set forth in the examples but should be given the broadest interpretation consistent with the description as a whole.

What is claimed is:

1. A method for recovering a parent radionuclide from a radionuclide generator, the radionuclide generator comprising the parent radionuclide adsorbed to a stationary phase, the method comprising a series of elutions comprising:
at least one elution with an alcohol;
at least one elution with a mineral acid; and
at least one elution with water;
where the at least one elution with a mineral acid is paused to soak the stationary phase with the mineral acid, and
the mineral acid does not comprise hydrochloric acid.

2. A method for recovering a parent radionuclide from a radionuclide generator comprising the parent radionuclide adsorbed to a stationary phase, the method comprising:
(i) eluting the stationary phase with an alcohol one or more times to obtain an alcohol eluate;
(ii) eluting the stationary phase with a mineral acid one or more times to obtain a mineral acid eluate;
(iii) eluting the stationary phase with water one or more times to obtain an aqueous eluate;
(iv) isolating the parent radionuclide, from the alcohol eluate obtained in step (i), the mineral acid eluate obtained in step (ii) and the aqueous eluate obtained in step (iii);
where step (ii) comprises pausing the one or more mineral acid elution to soak the stationary phase with the mineral acid, and
the mineral acid does not comprise hydrochloric acid.

3. A parent radionuclide recovered according to the method of claim 1.

4. A method for recycling a parent radionuclide from a first radionuclide generator for reuse in a second radionuclide generator, the method comprising,
(i) providing a first radionuclide generator, the radionuclide generator comprising the parent radionuclide adsorbed to a stationary phase;
(ii) eluting the stationary phase of the first radionuclide generator with an alcohol one or more times to obtain an alcohol eluate;
(iii) eluting the stationary phase of the first radionuclide generator with a mineral acid one or more times to obtain a mineral acid eluate;
(iv) eluting the stationary phase of the first radionuclide generator with water one or more times to obtain an aqueous eluate;
(v) isolating the parent radionuclide from the alcohol eluate obtained in step (ii), the mineral acid eluate obtained in step (iii) and the aqueous eluate obtained in step (iv);
(vi) loading the isolated parent radionuclide into the second radionuclide generator, such that the parent radionuclide is adsorbed to a stationary phase of the second radionuclide generator;
where step (ii) comprises pausing the one or more mineral acid elution to soak the stationary phase with the mineral acid, and
the mineral acid does not comprise hydrochloric acid.

5. The method of claim 1, wherein the mineral acid comprises an acid other than hydrochloric acid.

6. The method of claim 1, wherein the stationary phase is soaked with the mineral acid for about 12 hours or more.

7. The method of claim 1, wherein the stationary phase is soaked with the mineral acid for about 24 hours or more, about 36 hours or more, about 48 hours or more, about 72 hours or more, between about 12-50 hours, between about 20-55 hours, between about 20-50 hours, between about 12-24 hours, between about 15-24 hours, between about 20-25 hours.

8. The method of claim 1, wherein the alcohol is methanol.

9. The method of claim 1, wherein the water is ultrapure water (e.g. milli Q) or deionized water.

10. The method of claim 1, wherein the parent radionuclide is germanium-68 (Ge-68)

11. The method of claim 1, wherein the radionuclide generator is a germanium-68/gallium-68 (Ge-68/Ga-68) generator.

12. The method of claim 1, wherein the mineral acid is a concentrated mineral acid.

13. The method of claim 1, wherein the mineral acid comprises one or more hydrogen halide acid.

14. The method of claim 1, wherein the hydrogen halide acid is hydroiodic acid and/or hydrobromic acid.

15. The method of claim 1, wherein the hydroiodic acid has a strength of at least about 40%, at least about 50%, about 50-60%, preferably about 57%.

16. The method of claim 1, wherein the hydrobromic acid has a strength of at least about 30%, at least about 40%, about 40-50%, preferably about 48%.

17. The method of claim 1, wherein the alcohol elution step comprises a single elution.

18. The method of claim 1, wherein the mineral acid elution step comprises multiple elutions with mineral acid, at least 2 elutions, at least 3, at least 4.

19. The method of claim 1, wherein the step of eluting with water is carried out after each mineral acid elution.

20. The method of claim 1, wherein the step of eluting with water is carried out after each of the one or more mineral acid elutions in step (ii).

21. The method of claim 1, wherein the step of eluting with water is carried out after each of the one or more mineral acid elutions in step (iii).

22. The method of claim 1, wherein the parent radionuclide is isolated using liquid-liquid extraction.

23. The method of claim 1, wherein the parent radionuclide is extracted using a chlorinated organic solvent, such as carbon tetrachloride, chloroform, dichloroethane, dichloromethane, aromatic solvents such as benzene or toluene, preferably chloroform.

24. The method of claim 1, wherein the method optionally comprises repeating one or more of steps (i)-(iii).

25. The method of claim 1, wherein the method optionally comprises repeating one or more of steps (ii)-(iv).

26. The method of claim 1, wherein the stationary phase is an ion exchange resin.

27. The method of claim 1, wherein the generator is a chromatography column

28. The method of claim 1, wherein the stationary phase comprises a silica matrix, such as octadecyl silica resin (C-18).

29. The method of claim 1, wherein the stationary phase comprises an organic chelating group bound to the silica matrix for retaining the parent nuclide.

30. The method of claim 1, wherein the organic chelating group comprises laurylgallate.

31. The method of claim 1, wherein the organic chelating group consists of laurylgallate.

32. The method of claim 1, wherein the chemical purity of the recovered parent radionuclide is at least about 80%, at least about 85%, at least about 90%, at least about 91%, at least about 92%, at least about 93%, at least about 94%, at least about 95%.
